(19) United States
(12) Patent Application Publication
(10) Pub. No.: US 2006/0082739 A1
(43) Pub. Date: Apr. 20, 2006

(54) PANEL LOCATING METHOD OF A PROJECTING SYSTEM

(76) Inventors: Hsiu Feng Yeh, Hsin-Chu Hsien (TW); Ting Hsien Shu, Tai-Chung Hsien (TW)

Correspondence Address: NORTH AMERICA INTELLECTUAL PROPERTY CORPORATION, P.O. BOX 506, MERRIFIELD, VA, 22116, US

(21) Appl. No.: 10/711,951

(22) Filed: Oct. 15, 2004

(51) Int. Cl. G03B 21/00

(52) U.S. Cl. 353/121

(57) ABSTRACT

A panel locating method of a projecting system. A first panel is fixed on a first surface of an optical kernel, and an image of the first panel is projected to a lens via the optical kernel. Position of the lens is adjusted to a focus position, and the second and third panels are mounted onto the second and third surfaces of the optical kernel with a pin-to-hole method. Then, positions of the second and third panels are tuned to make images of the second and third panels focusing at the focus position. Finally, positions of the second and third panels are fixed.

### BACKGROUND OF INVENTION

1. Field of the Invention

The present invention is generally related to a panel locating method of a projecting system, and more particularly to a panel locating method with a reduced fabrication time and reduced cost.

2. Description of the Prior Art

A projector is an apparatus for projecting images onto a large size screen by optical projection. A projector can be substantially classified into four types, CRT projector, liquid crystal display (LCD) projector, digital light processing (DLP) projector, and liquid crystal on silicon (LCoS) projector, depending on which light valve is adopted. The LCD projector is a transmission projector for its perviousness to light, and LCoS, DLP projectors are reflection projectors because they form images relying on light reflection.

The LCoS projector and the LCD projector are based on similar principles, but the LCoS projector modulates light signals emitted from a light source to a screen by an LCoS panel. In fabricating the LCoS panel, CMOS wafer is adopted as a circuit substrate and a reflection layer. Following that, a liquid crystal layer is coated and packed with a glass panel. Since a reflection structure is adopted in the LCoS projector, light signals emitted from the light source do not pass through the LCoS panel. As a result, the LCoS projector is a reflection projector. On the contrary, in an LCD projector, the light source is mounted behind the LCD panel, and light signals pass through the LCD panel. Therefore, the LCD projector is a transmission projector.

However, in the prior art, a panel is fixed on an optical kernel with a pin-to-hole method no matter whether the LCD panel or the LCoS panel is adopted. FIG. 1 shows a schematic view of a projecting system in the prior art. In FIG. 1, a panel 106 is first mounted onto the optical kernel 104 with the pin 108, and the other two panels 106 are subsequently mounted onto the optical kernel 104 in the same manner. After the three panels 106 are mounted, a modulation step is performed to stack images of the three panels 106 and focus the images on the lens 102. Usually, a six-axis adjustment jig is adopted to assist on the modulation step. After the three color images emitted from the three panels 106 are stacked, the three panels 106 are fixed on the optical kernel 104 using an ultra violet seal or a weld. When the ultra violet seal shrinks or other parts shrink or expand with the temperature, multidirectional cumulative tolerance occurs in the conventional assembly and leads to image misalignment. In addition, it requires much time to adjust three panels 106 so as to stack three images and may lag the fabrication.

FIG. 2 shows another schematic view of a projecting system in the prior art. As shown in FIG. 2, the panels 106 are fixed on the optical kernel 104 directly without the pin-to-hole adjustment. The possibility of image misalignment resulting from cumulative tolerance may be prevented in this way. However, the three color images of the three panels 106 do not focus with the optimum focal length.

### SUMMARY OF INVENTION

It is therefore a primary objective of the claimed invention to provide a panel locating method with reduced fabrication time and reduced cost to solve the problems in conventional methods.

According to the claimed invention, a panel locating method of a projecting system is provided. A first panel is fixed on a first surface of an optical kernel, and an image of the first panel is projected to a lens via the optical kernel. Following that, the position of the lens is adjusted to a focus position and is fixed. A second panel and a third panel are subsequently mounted onto a second surface and a third surface of the optical kernel with a pin-to-hole method. Then, the position of the second panel and the position of the third panel are tuned to focus the images of the second panel and the third panel at the focus position via the optical kernel. Next, the position of the second panel and the position of the third panel are fixed.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 shows a schematic view of a projecting system in the prior art;

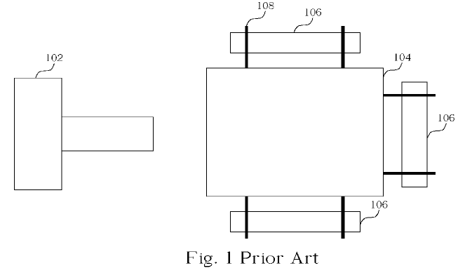

FIG. 2 shows another schematic view of a projecting system in the prior art;

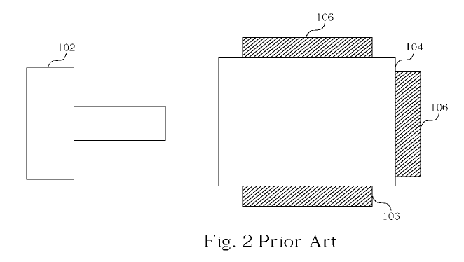

FIG. 3 shows a schematic view of a projecting system according to the present invention;

### DETAILED DESCRIPTION

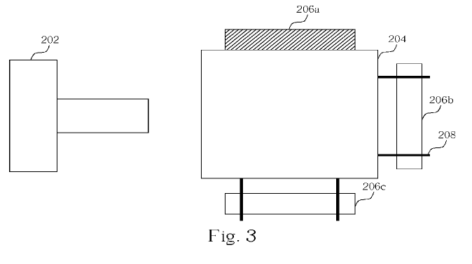

Please refer to FIG. 3. FIG. 3 is a schematic view illustrating a preferred embodiment of the present invention. As shown in FIG. 3, a lens 202, an optical kernel 204 and three panels 206a, 206b, 206c are included in a projecting system. The panel assembly of the projecting system according to the present invention in FIG. 3 is different from those in the prior art, even though they have similar components.

The panel 206a is fixed on one of the surfaces of the optical kernel 204 first. In this event, an image of the panel 206a is projected to the lens 202 via the optical kernel 204. Following that, the relative position of the lens 202 and the optical kernel 204 is adjusted so as to focus the image of the panel 206a on the lens 202. At this time, the position of the lens 202 is designated as a focus position of the projecting system. After the relative position of the panel 206a is fixed, the optical kernel 204, and the lens 202 are adjusted and fixed, and the panel 206b and the panel 206c are thereafter mounted onto the optical kernel 204. The panel 206b and the panel 206c may be mounted with a pin-to-hole method.

There is still space for tuning after the panel 206b and the panel 206c are mounted with a pin-to-hole method. Since the panel 206b and the panel 206c are projected to the lens 202 via the optical kernel 204, the positions of the panel 206b and the panel 206c are tuned so as to focus both the image of the panel 206b and the image of the panel 206c on the lens 202. After the positions of the panel 206b and the panel 206c are tuned, images of the three panels 206a, 206b, and 206c are stacked and focused on the lens 202 so as to project an integrated colorful image. The panel 206b and the panel 206c are fixed using an ultra violate seal or a weld. The assembly process according to the present invention is thus completed.

The optical kernel 204 in this embodiment includes a plurality of color filters. The color filters are pervious to light or reflect light selectively. In another words, the color filters, while in a specific direction, are pervious to or reflect light with a specific color, such as pervious to red light and reflecting green light in a given direction. This characteristic enables the optical kernel 204 to allow images to pass through the optical kernel 204 or to reflect images based on the colors of the images and thus focus them on the lens 202. In addition, the panels 206a, 206b and 206c used in the present invention may be LCD panels or LCoS panels. If LCD panels are adopted, the images are projected by transmission. If LCoS panels are adopted, the images are projected by reflection. Though three panels 206a, 206b, and 206c are adopted to illustrate the preferred embodiment of the present invention, however, two or more panels may be adopted in actual practice depending on the arrangement of the panels and the optical kernel 204.

Compared to conventional methods of assembly, the panel locating method of the present invention reduces the adjustment steps and thus decreases cost and time of the jig adjustment. Even more, the panel locating method of the present invention prevents the possibility of image misalignment caused by cumulative tolerance. In addition, the possibility of the projecting system contaminated by dust is reduced by the simplification of the modulation steps, and therefore raises the reliability of products.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A panel locating method of a projecting system, comprising:
fixing a first panel on a first surface of an optical kernel, and an image of the first panel being projected to a lens via the optical kernel;
adjusting the position of the lens to a focus position, and fixing the lens;
mounting a second panel onto a second surface of the optical kernel with a pin-to-hole method;
tuning the position of the second panel to focus an image of the second panel at the focus position via the optical kernel; and
fixing the position of the second panel.

2. The panel locating method of claim 1, wherein the optical kernel comprises a plurality of color filters.

3. The panel locating method of claim 2, wherein the color filters, while in a specific direction, are pervious to or reflect light with a specific color.

4. The panel locating method of claim 1, wherein the first panel and the second panel are liquid crystal panels or liquid crystal on silicon panels.

5. The panel locating method of claim 1, wherein the images of the first panel and the second panel are stacked into an integrated image at the focus position.

6. A panel locating method of a projecting system, comprising:
fixing a first panel on a first surface of an optical kernel, and an image of the first panel being projected to a lens via the optical kernel;
adjusting the position of the lens to a focus position, and fixing the lens;
mounting a second panel onto a second surface of the optical kernel with a pin-to-hole method;
mounting a third panel onto a third surface of the optical kernel with a pin-to-hole method;
tuning the positions of the second panel and the third panel to focus the images of the second panel and the third panel at the focus position via the optical kernel; and
fixing the positions of the second panel and the third panel.

7. The panel locating method of claim 6, wherein the optical kernel comprises a plurality of color filters.

8. The panel locating method of claim 7, wherein the color filters, while in a specific direction, are pervious to or reflect light with a specific color.

9. The panel locating method of claim 6, wherein the first panel, the second panel, and the third panel are liquid crystal panels or liquid crystal on silicon panels.

10. The panel locating method of claim 6, wherein the images of the first panel, the second panel and the third panel are stacked into an integrated image at the focus position.

11. A panel locating method of a projecting system, comprising:
fixing a first panel on a first surface of an optical kernel, and an image of the first panel being projected to a lens via the optical kernel;
adjusting the position of the lens to a focus position, and fixing the lens; mounting a plurality of second panels onto a plurality of second surfaces of the optical kernel with a pin-to-hole method;
tuning the positions of the second panels to focus images of the second panels at the focus position via the optical kernel; and
fixing the positions of the second panels.

12. The panel locating method of claim 11, wherein the optical kernel comprises a plurality of color filters.

13. The panel locating method of claim 12, wherein the color filters, while in a specific direction, are pervious to or reflect light with a specific color.

14. The panel locating method of claim 11, wherein the first panel and the second panels are liquid crystal panels or liquid crystal on silicon panels.

15. The panel locating method of claim 11, wherein the images of the first panel and the second panels are stacked into an integrated image at the focus position.
